(19) United States
(12) Patent Application Publication
(10) Pub. No.: US 2011/0219588 A1
(43) Pub. Date: Sep. 15, 2011

(54) ATTACHMENT STRUCTURE OF CLIP AND MOUNTING-SUBJECT MEMBER

(75) Inventor: Masatoshi Inoue, Kanagawa (JP)

(73) Assignee: PIOLAX INC., Yokohama-shi, Kanagawa (JP)

(21) Appl. No.: 12/998,573

(22) PCT Filed: Aug. 7, 2009
(86) PCT No.: PCT/JP2009/064019

§ 371 Date: May 4, 2011

(30) Foreign Application Priority Data
Nov. 5, 2008 (JP) 2008-284269

(51) Int. Cl. F16B 2/20

(52) U.S. Cl. 24/458

(57) ABSTRACT

An attachment structure of a clip and a mounting-subject member is provided which enables the clip to easily be attached to the mounting-subject member and which can prevent the dislodgement of the clip from the mounting-subject member in the attached state.

This attachment structure is intended to attach a clip 10 including a flange portion 12 and locking legs 13 and a mounting-subject member 30 together. The mounting-subject member 30 includes an insertion hole 35 having an insertion position 36 where the locking legs 13 is insertable and a fixing position 37 where the locking legs 13 is movable and the locking legs 13 are held at a certain location, fastening pieces 45 which are disposed above a front surface of the flange portion 12 so as to restrict the movement of the locking legs 13 in a dislodgement direction, and a unidirectional-movement-prevention unit which permits the insertion of the locking legs 13 from the insertion position 36 of the insertion hole 35 and restricts the moving back of the locking legs 13 towards the insertion position 36 when the locking legs 13 move to the fixing position 37.

### TECHNICAL FIELD

The present invention relates to an attachment structure of a clip and a mounting-subject member for fixing the mounting-subject member to a mount-base member.

### BACKGROUND ART

For example, sometimes, between an automobile panel and an external member, a member for supporting the external member may be disposed. Generally, such supporting member (mounting-subject member) is fixed to the panel (mount-base member) via a clip. For example, as structures for fixing the mounting-subject member to the mount-base member via the clip, following structures are proposed.

Patent Document 1 discloses a clip including: a male member having a head portion and a shaft portion; and a female member having a flange portion, a barrel portion and plural elastic leg pieces from a lower end of the barrel portion to have a substantially cylindrical shape. By inserting the shaft portion into the barrel portion, a temporary holding state is attained such that the male member is temporarily held in the female member. And, by further inserting the shaft portion, a final holding state is attained such that the male member is properly held in the female member while sandwiching a mounting-subject member and a mount-base member between the diametrically-expanded leg pieces and the flange portion. Engagement claw portions to be brought into engagement with a through hole formed in the mounting-subject member are projected from a rear surface of the flange portion at two facing locations.

By bringing the male member and the female member into the temporary holding state and inserting the barrel portion and the elastic leg pieces of the female member into amounting hole in the mounting-subject member, the engagement claw portions on the flange portion of the female member are brought into engagement with the through hole in the mounting-subject member, whereby the clip is temporarily held in the mounting-subject member. Then, the cylindrical portion and the elastic leg pieces of the clip are inserted into amounting hole in the mount-base member and the male member is further inserted into the female member, whereby the elastic leg pieces are diametrically expanded so as to be brought into engagement with the mounting hole in the mount-base member. Thus, the mounting-subject member is fixed to the mount-base member.

Patent Document 2 discloses a member connection apparatus for connecting a mounting-subject member such as a panel to a mount-base member such as a vehicle body with a clip. The clip includes a pin made up of a head portion and a shaft portion and a bush made up of a flange and a shaft portion. The shaft portion has plural legs to be diametrically expanded when the pin is inserted thereinto. The bush shaft portion has two radially outwardly projecting locking portions at a position apart from the bush position by a length corresponding to a thickness of the mounting-subject member around a mounting hole.

The two locking portions are respectively brought into engagement with a circumferential edge of the mounting hole in the mounting-subject member from a rear side by inserting the shaft portion of the bush into the mounting hole in the mounting-subject member. Further, by inserting the pin into the bush, an elastic locking claw provided on the bush is brought into engagement with the pin, whereby the clip is temporarily held in the mounting-subject member. Thereafter, the bush is inserted into amounting hole in the mount-base member and the pin is then inserted deeply into the bush, whereby the legs at the bush shaft portion are diametrically expanded to thereby be brought into engagement with the mounting hole, and the mounting-subject member is fixed to the mount-base member.
Patent Document 1: JP-2002-106531-A
Patent Document 2: JP-2004-028244-A

### DISCLOSURE OF INVENTION

### Problem to be Solved by Invention

In Patent Document 1, the two engagement claw portions projected from the rear surface of the flange portion of the female member are brought into engagement with the through hole in the mounting-subject member by inserting the engagement claw portions into the through hole in the mounting-subject member while deflecting them, whereby the clip is temporarily held to the mounting-subject member. However, since the two engagement claw portions are inserted into the through hole while being deflected, a certain magnitude of pushing force is required. However, the flange portion of the female member is relatively small in diameter and is hence difficult to be gripped, and the female member needs to be inserted into the through hole so that the male member is not inserted thereinto, leading to a problem with workability in attachment.

Patent Document 2 also has a similar problem to that of Patent Document 1. Namely, since the two locking portions are brought into engagement with the mounting hole by inserting the shaft portion into the mounting hole in the mounting-subject member while gripping on the flange of the bush, a certain pushing force is required. However, the flange portion of the female member is small in diameter and is hence difficult to be gripped, and additionally, the female member needs to be inserted into the through hole in the mounting hole so that the male member is not inserted thereinto, leading to a problem with workability in attachment.

Further, in Patent Document 2, when the clip is temporarily held in the mounting-subject member, the shaft portion of the bush on which the two locking portions for temporary holding the clip are provided projects from the rear side of the mounting hole in the mounting-subject member. Thus, when an unexpected external force is exerted on the shaft portion, the two locking portions may be dislodged from the mounting hole, and the temporarily held state may be released.

An object of the invention is to provide an attachment structure of a clip and a mounting-subject member which enables an easy attachment of a clip to a mounting-subject member and which surely prevents the dislodgement of the clip from the mounting-subject member in the temporarily attached state.

### Means for Solving Problem

With a view to attaining the object, according to a first invention, there is provided an attachment structure of a clip and a mounting-subject member, wherein the clip includes: a flange portion; and a locking leg extending from a rear surface of the flange portion to be inserted into a mounting hole in a mount-base member to thereby fix the mounting-subject member to the mount-base member, and wherein the mounting-subject member includes: an insertion hole having an insertion position which enables the locking leg of the clip to be inserted along an inserting direction and a fixing position which communicates with the insertion position and which enables the locking leg to be moved in a direction perpendicular to the inserting direction to thereby hold the locking leg at a certain location; a fastening piece which is disposed above a front surface of the flange portion and which restricts a movement of the locking leg in a dislodgement direction when the locking leg is moved to the fixing position and the flange portion is located in the fixing position; and a unidirectional-movement-prevention unit which permits an insertion of the locking leg to the insertion position of the insertion hole and which restricts a returning movement of the locking leg to the insertion position when the locking leg has moved to the fixing position.

According to the invention, by moving the locking leg of the clip after the locking leg has been inserted into the insertion hole in the mounting-subject member from the insertion position, the locking leg is restricted from moving in the dislodgement direction by the fastening piece disposed above the front surface of the flange portion, whereby the locking leg is held without the dislodgement. Further, the locking leg is also restricted from moving back to the insertion position by the unidirectional-movement-prevention unit. Thus, the clip can be held in the fixing position of the insertion hole. Thereafter, the locking leg of the clip is inserted into the mounting hole in the mount-base member so as to be brought into engagement therewith, thereby fixing the mounting-subject member to the mount-base member via the clip.

In this attachment structure, the clip can be attached to the mounting-subject member by simply moving the clip to the fixing position, thereby improving the workability in attachment.

Further, the clip is restricted from moving in the dislodgement direction to be held without the dislodgement by the fastening piece and is restricted from moving back to the insertion position and is prevented from returning thereto by the unidirectional-movement-prevention unit. Thus, the clip can be held firmly in the fixing position, and for example, the dislodgement of the clip from the mounting-subject member is surely prevented even if an unexpected external force is exerted, thereby surely attaching the clip to the mounting-subject member.

According to a second invention, in the first invention, the unidirectional-movement-prevention unit is formed as a flexible elastic piece extending from an inner circumference of the insertion hole at a side of the insertion position towards an axis of the locking leg when positioned in the fixing position.

According to the invention above, the elastic piece as the unidirectional-movement-prevention unit extends towards the axis of the locking leg when the locking leg is moved to the fixing position of the insertion hole. Therefore, even though an outside diameter of the locking leg of the clip is changed to some extent, the elastic piece can be brought into abutment with an outer circumference of the locking leg when the locking leg attempts to move back to the insertion position, thereby surely restricting the return of the locking leg to the insertion position.

According to a third invention, in the second invention, the elastic piece includes a pair of elastic pieces respectively extending from both inner circumferential positions of the insertion hole at the insertion position side to have a gradually tapered shape.

According to the invention above, when the locking leg of the clip attempts to move from the insertion position to the fixing position in the insertion hole, the locking leg moves while expanding the pair of elastic pieces forming the gradually tapered shape. Therefore, the locking leg is allowed to move smoothly, and once the locking leg is disposed in the fixing position, the pair of elastic pieces forming the gradually tapered shape are brought into abutment with the outer circumference of the locking leg with good balance. Thus, the locking leg is surely restricted from moving back to the insertion position so as to be held firmly in the fixing position.

According to a fourth invention, in the first invention, the unidirectional-movement-prevention unit includes an elastic claw piece extending from an inner circumference of the insertion hole at a side of the insertion position towards a side of the fixing position and being deflectable in the inserting direction of the locking leg, and the elastic claw piece is brought into engagement with an outer circumference of the flange portion when the locking leg moves to the fixing position.

According to the invention above, when the locking leg of the clip moves to the fixing position of the insertion hole, the elastic claw piece as the unidirectional-movement-prevention unit is brought into engagement with the outer circumference of the flange portion which is larger in diameter, thereby surely restricting the return of the locking leg to the insertion position.

According to a fifth invention, in any of first to fourth invention, a step portion of a certain height is provided on the clip insertion side of the mounting-subject member a circumferential edge of the insertion position of the insertion hole, and the flange portion of the clip rides on the step portion when the flange portion is positioned in the insertion position of the insertion hole, and the step portion is brought into engagement with a circumferential edge of the flange portion when the flange portion is positioned in the fixing position.

According to the invention above, when the locking leg of the clip is inserted into the insertion position of the insertion hole, the flange portion rides on the step portion. Thus, when the locking leg is moved to the fixing position side in that state, a front portion of the flange portion with respect to the moving direction is inclined downwards, whereby the flange portion can easily plunge under the fastening piece, thereby improving the workability in attachment of the clip. Further, when the flange portion is moved to the fixing position, the step portion is brought into engagement with the circumferential edge of the flange portion, and therefore, the return of the locking leg to the insertion position can be further surely restricted.

According to a sixth invention, in any of first to fifth inventions, the clip is a two-piece clip having a grommet having the flange portion and the locking leg and a pin to be inserted into the grommet, the clip is inserted into the insertion hole in the mounting-subject member and the mounting hole in the mount-base member in a state where the pin is inserted halfway into the grommet, and the locking leg is diametrically expanded to be fixed in the mounting hole by inserting the pin deeper into the grommet.

According to the invention above, with the pin inserted halfway into the grommet, the locking leg is inserted into the insertion hole in the mounting-subject member from the insertion position and is then moved to the fixing position, so that the two-piece clip is attached to the mounting-subject member. Thereafter, the locking leg of the grommet is inserted into the mounting hole in the mount-base member, and the pin is inserted deeper into the grommet in that state so that the locking leg is expanded diametrically so as to be brought into engagement with the mounting hole, thereby fixing the mounting-subject member to the mount-base member.

In this way, after the two-piece clip is attached to the mounting-subject member, the locking leg is inserted into the mounting hole. Thus, the mounting-subject member can be fixed to the mount-base member by simply inserting the pin deeper, thereby improving the workability. Further, when the locking leg is inserted into the mounting hole, the insertion resistance can be reduced.

### Advantage of Invention

According to the invention, the clip can be attached to the mounting-subject member by simply inserting the locking leg of the clip from the insertion position of the insertion hole and moving it to the fixing position, thereby improving the workability in attachment. Further, the clip is restricted from moving in the dislodgement direction to be held without the dislodgement by the fastening piece and is restricted from moving back to the insertion position by the unidirectional-movement-prevention unit. Thus, the clip can be held firmly in the fixing position, and the dislodgement of the clip from the mounting-subject member can be surely prevented even if an unexpected external force is exerted, thereby surely attaching the clip to the mounting-subject member.

### BRIEF DESCRIPTION OF DRAWINGS

FIG. 1 is a perspective view showing an embodiment of an attachment structure of a clip and a mounting-subject member according to the invention.

FIG. 2 is an enlarged perspective view of a main part of the attachment structure.

FIGS. 3A and 3B show a state where a locking leg is inserted in an insertion position in the attachment structure, of which FIG. 3A is a plan view of the state, and FIG. 3B is a sectional view taken along the line B-B and seen in a direction indicated by arrows.

FIGS. 4A and 4B show a state where the locking leg is fixed in a fixing position in the attachment structure, of which FIG. 4A is a plan view of the state, and FIG. 4B is a sectional view.

FIG. 5 is an explanatory drawing showing a state where the clip is attached to the mounting-subject member in the attachment structure.

FIG. 6 is an explanatory drawing showing a state where the mounting-subject member is fixed to a mount-base member by use of the attachment structure.

FIGS. 7A and 7B show another embodiment of an attachment structure of a clip and a mounting-subject member according to the invention showing a state where a locking leg is inserted in an insertion position, of which FIG. 7A is a plan view of the state, and FIG. 7B is a sectional view.

FIGS. 8A and 8B show a state where the locking leg is fixed in a fixing position in the attachment structure, of which FIG. 8A is a plan view of the state, and FIG. 8B is a sectional view.

FIG. 9 is an enlarged perspective view of the main part showing a state where the clip is attached to the mounting-subject member in the attachment structure.

FIGS. 10A and 10B show a further embodiment of an attachment structure of a clip and a mounting-subject member according to the invention showing a state where a locking leg is inserted in an insertion position, of which FIG. 10A is a plan view of the state, and FIG. 10B is a sectional view.

FIGS. 11A and 11B show a state in the locking leg is fixed in a fixing position in the attachment structure, of which FIG. 11A is a plan view of the state, and FIG. 11B is a sectional view.

### DESCRIPTION OF REFERENCE NUMERALS

1 Mount-base member; 3 Mounting hole; 10 Clip; 11 Grommet; 12 Flange portion; 13 Locking leg; 15 Pin; 30 Mounting-subject member; 35 Insertion hole; 36 Insertion position; 37 Fixing position; 40 Elastic piece; 41 Step portion; 44 Elastic claw piece; 45 Fastening piece.

### MODE FOR CARRYING OUT INVENTION

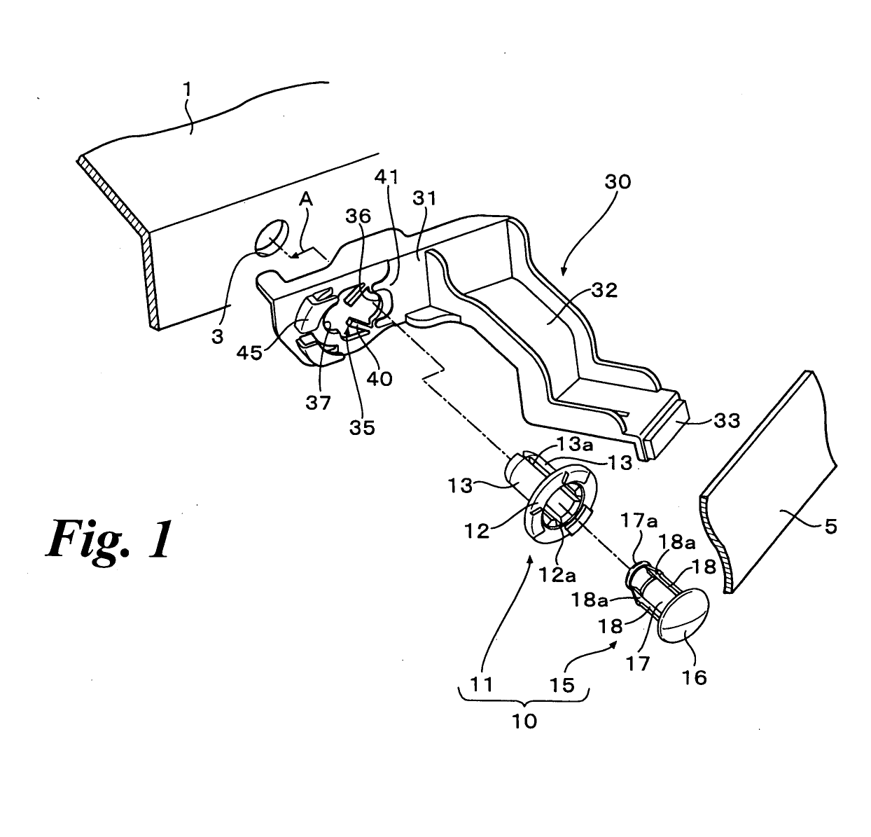

Hereinafter, referring to FIGS. 1 to 6, an embodiment of an attachment structure of a clip and a mounting-subject member according to the invention will be described.

As shown in FIG. 1, this attachment structure of a clip and a mounting-subject member (hereinafter, referred to as an “attachment structure) is intended to attach a mounting bracket 30 acting as a support bracket for supporting an external member 5 disposed on an outer side of a mount-base member 1 such as a body panel to the mount-base member 1 via a clip 10. There being imposed no specific limitation on the mounting-subject member 30, a garnish or a trim board may be adopted as the mounting-subject member 30.

As shown in FIG. 1, the clip 10 used in the attachment structure of this embodiment is a so-called two-piece clip made up of a grommet 11 and a pin 15 which is inserted into the grommet 11. The grommet 11 includes an annular flange portion 12 having a pin insertion hole 12a in a center thereof and plural locking legs 13 extending from a circumferential edge of the insertion hole 12a on one surface of the flange portion 12. The plural locking legs 13 are formed by dividing a cylindrical portion provided on the one surface of the flange portion 12 by slits 13a, and the locking legs 13 are flexible.

On the other hand, the pin 15 includes a disk-shaped head portion 16 and a shaft portion 17 suspended from a center of one surface of the head portion 16. Ribs 18 are formed on an outer circumferential surface of the shaft portion 17 so as to enter the slits 13a in the grommet 11, and a temporarily holding claw 18a is formed in a position along the length of each of the ribs 18. Further, an annular projecting portion 17a is provided at a distal end of the shaft portion 17 so as to project therefrom.

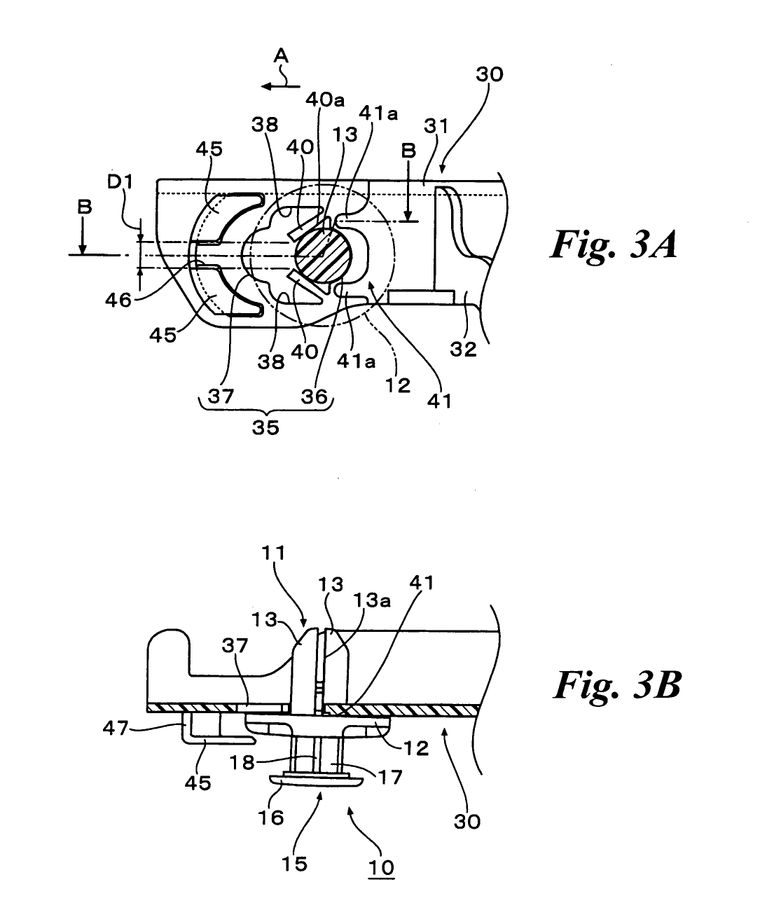

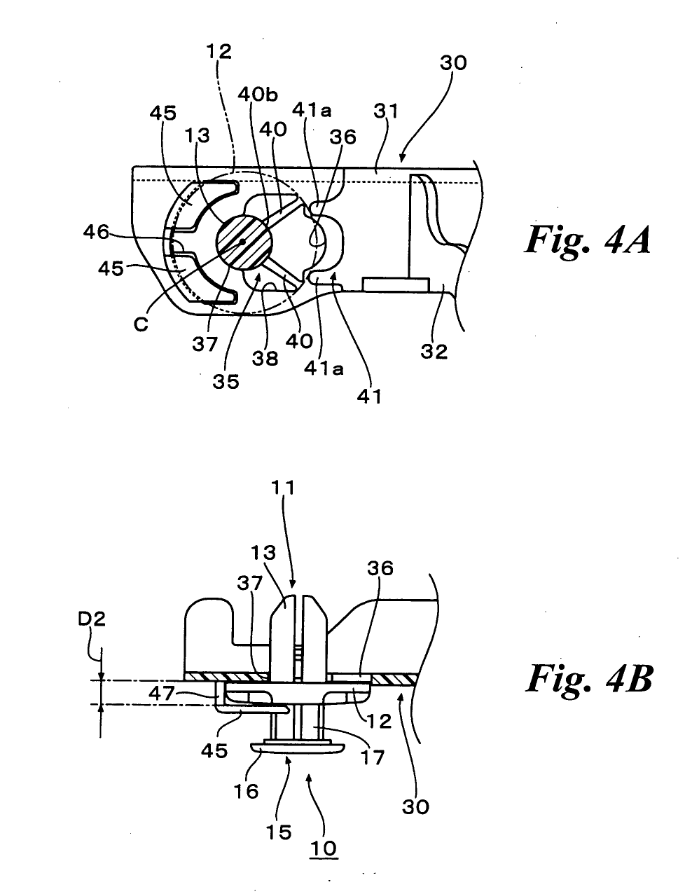

Then, when the shaft portion 17 of the pin 15 is inserted halfway into the grommet 11, the temporarily holding claws 18a are brought into engagement with a circumferential edge on a rear surface of the pin insertion hole 12a, whereby the pin 15 is temporarily held in the grommet 11 with the locking legs 13 prevented from being expanded diametrically so that the leg portions 13 can be inserted into an insertion hole 35 (which will be described later) in the mounting-subject member 30 and a mounting hole 3 in the mount-base member 1 (refer to FIG. 3B). When the pin 15 is inserted deeper into the grommet 11 in that state, projecting portions, not shown, on inner sides of the locking legs 13 are pressed against by the shaft portion 17, whereby the locking legs 13 are inserted to be expanded diametrically. Then, the projecting portions ride over the annular projecting portion 17a so as to be brought into engagement with a proximal side of the annular projecting portion 17a, whereby the locking legs 13 are kept staying in the diametrically expanded state so as to be brought into engagement with the mounting hole 3 (refer to FIG. 6). The locking legs 13 shown in FIGS. 3A, 4B are hatched so as to be conspicuous.

Next, the structure of the mounting-subject member 30 will be described. As described above, the mounting-subject member 30 of this embodiment is fixed to the mount-base member 1 so as to function as the support bracket of the external member 5. As shown in FIG. 1, this mounting-subject member 30 has a base portion 31 which is fixed to the mount-base member 1 and which extends in a certain direction, a support portion 32 extending from one end of the base portion 31 with respect to a length direction thereof towards the external member 5 into a certain shape, and an elastic member 33 secured onto a distal end face of the support portion 32.

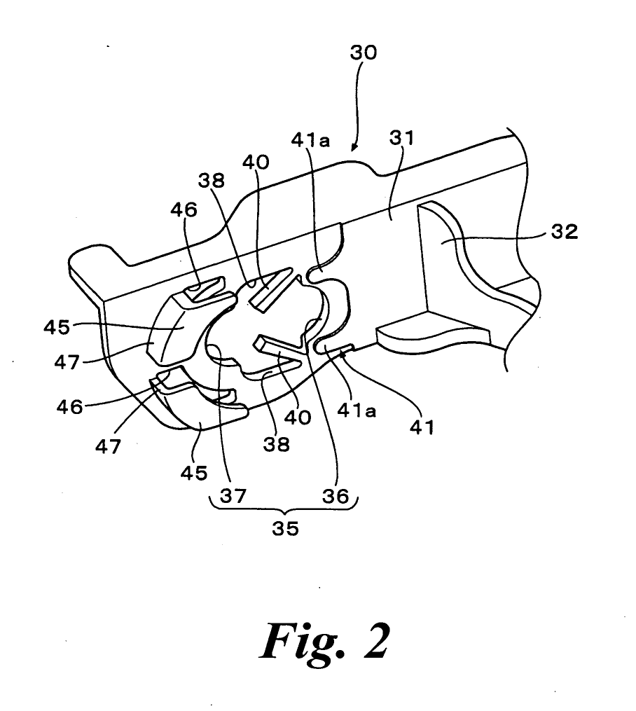

Also, referring to FIG. 2, the insertion hole 35 is formed in the other end side of the base portion 31 with respect to the length direction into which the locking legs 13 of the clip 10 are to be inserted. This insertion hole 35 has an insertion position 36 which enables the locking legs 13 of the clip 10 to be inserted along an inserting direction and a fixing position 37 which communicates with the insertion position 36 and which enables the locking legs 13 to move in a direction perpendicular to the inserting direction to thereby hold the locking legs 13 at a certain location.

In the insertion hole 35 of this embodiment, the insertion position 36 is provided at a side facing the support portion 32, and the fixing position 37 is provided so as to connect to the insertion position 36 in a direction in which the fixing position 37 moves away from the support portion 32. After the locking legs 13 are inserted at the insertion position 36, the locking legs 13 are moved in a direction indicated by an arrow A (refer to FIGS. 1, 3A) which is perpendicular to the inserting direction of the locking legs 13 so as to be disposed in the fixing position 37. An inner circumference at the insertion position 36 side and an inner circumference at the fixing position 37 side of the insertion hole 35 are formed into arc-like shapes so as to match outer circumferential shapes of the locking legs 13 of the clip 10.

Further, a pair of flexible elastic pieces 40, 40 are provided in positions along both side portions of the insertion hole 35 which extend in the moving direction (the direction indicated by the arrow A) of the locking legs 13 and between the insertion portion 36 and the fixing position 37 so as to extend into a gradually tapered shape. A pair of clearance grooves 38, 38 are formed on respective fixing position 37 sides of the pair of elastic pieces 40, 40 so as to enable the elastic pieces 40, 40 to be deflected outwards.

As shown in FIG. 4A, the pair of elastic pieces 40, 40 are provided at an open angle which enables the locking legs 13 to be inserted in the insertion position 36 of the insertion hole 35 and extend towards an axis or center C of the locking legs 13 when the locking legs 13 are positioned in the fixing position 37 at distal ends thereof. Further, as shown in FIG. 3A, a distance D1 between the distal ends of the pair of elastic pieces 40, 40 is set smaller than at least an outside diameter of the locking legs 13. In this embodiment, in a state where the locking legs 13 are inserted in the insertion position 36, the locking legs 13 are brought into abutment with inner surfaces 40a, 40a of the pair of elastic pieces 40, 40 (refer to FIG. 3A), and when the locking legs 13 are moved to the fixing position 37, distal end faces 40b of the elastic pieces 40 are brought into abutment with the outer circumferences of the locking legs 13 (refer to FIG. 4A).

Then, the pair of elastic pieces 40, 40 permit the insertion of the locking legs 13 to the insertion position 36 of the insertion hole 35. When the locking legs 13 are moved towards the fixing position 37, the inner surfaces 40a are pressed against by the locking legs 13 to thereby be forcibly expanded towards the clearance grooves 38. When the locking legs 13 reach the fixing position 37, the pair of elastic pieces 40, 40 are elastically restored and are closed again into the gradually tapered shape, whereupon the distal end faces 40b of the elastic pieces 40 are brought into abutment with the outer circumferences of the locking legs 13. In this state, even if the locking legs 13 are attempted to be moved towards the insertion position 36, the locking legs 13 are only brought into abutment with the respective distal end faces 40b of the elastic pieces 40, and the elastic pieces 40, 40 are prevented from being forcibly expanded, whereby the return of the locking legs 13 to the insertion portion 36 is restricted. Namely, in this embodiment, the pair of elastic pieces 40, 40 constitute a “unidirectional-movement-prevention unit” of the invention.

Referring again to FIG. 2, a step portion 41 of a certain height is provided on a clip insertion side of the mounting-subject member 30 and at a circumferential edge of the insertion position 36 of the insertion hole 35. The step portion 41 of this embodiment has a substantially U-shape when viewed from the clip insertion side (a front side) of the mounting-subject member 30, and both side portions 41a, 41a extend towards the insertion position 36. Then, when the flange portion 12 of the clip 10 is positioned in the insertion position 36 of the insertion hole 35, the flange portion 12 rides on the step portion (refer to FIGS. 3A, 3B), whereas when the flange portion 12 is positioned in the fixing position 37, distal ends of the side portions 41a, 41a of the step portion 41 are brought into engagement with a circumferential edge of the flange portion 12 (refer to FIGS. 4A, 4B). The configuration in which the “step portion is brought into engagement with the circumferential edge of the flange portion” may include a configuration in which the step portion 41 is brought into engagement with the outer circumference of the flange portion 12 in an abutting fashion when the clip is pulled towards the insertion position 36 side. For example, a gap may be present between the flange portion 12 and a distal end of the step portion 41 in the state shown in FIG. 4A.

Further, fastening pieces 45 are provided on the mounting-subject member 30 which are disposed above a front surface of the flange portion 12 and which restrict the movement of the locking legs 13 in a dislodgement direction when the locking legs 13 are moved to the fixing position 37 and the flange portion 12 is positioned in the fixing position 37. As shown in FIG. 2, a pair of arc-shaped through holes 46, 46 are formed in an outer circumferential edge of the insertion hole 35 of the mounting-subject member 30 which lies at the fixing position 37 side, and support walls 47, 47 are erected to a certain height from respective front circumferential edges (circumferential edge portions lying farther apart from the fixing position 37) of the through holes 46. The pair of arc-shaped fastening pieces 45, 45 extend, respectively, from upper end portions of the support walls 47, 47 so as to cover the corresponding through holes 46, 46. As shown in FIG. 4B, a distance D2 from the clip insertion side surface of the mounting-subject member 30 to an inner surface of the fastening piece 45 is set to be larger than at least a thickness of the flange portion 12 of the clip 10, so that the flange portion 12 is received, between the front surface of the mounting-subject member 30 and the fastening pieces 45 and the fastening pieces 45 are disposed above the front surface of the flange portion 12.

Next, a method for using the above attachment structure will be described.

Firstly, the pin 15 is inserted halfway into the grommet 11, and the temporarily holding claws 18a are brought into engagement with the circumferential edge on the rear side of the pin insertion hole 12a, whereby the pin 15 is temporarily held in the grommet 11 with the locking legs 13 prevented from being expanded diametrically.

Then, with the head portion 16 of the pin 15 gripped, the locking legs 13 of the clip 10 are inserted at the insertion position 36 on the front side of the insertion hole 35 in the mounting-subject member 30 as shown in FIG. 1. Thus, not only are the locking legs 13 protruded to a rear side of the insertion hole 35, but also the flange portion 12 rides on the step portion 41 (refer to FIGS. 3A, 3B).

Thereafter, with the head portion 16 of the pin 15 gripped, the locking legs 13 of the clip 10 are moved in the direction indicated by the arrow A (refer to FIGS. 1, 3A) while lightly inserting the clip 10 into the insertion hole 35. As this occurs, in this embodiment, since the flange portion 12 stays on the step portion 41, a front portion of the flange portion 12 with respect to the moving direction is inclined as shown in FIG. 3B.

Then, with the locking legs 13 caused to move accordingly, the inner surfaces 4a of the elastic pieces 40 are pressed against, and the locking legs 13 move while forcibly expanding the pair of elastic pieces 40, 40 towards the clearance grooves 38. Then, when the locking legs 13 reach the fixing position 37, the pair of elastic pieces 40, 40 are elastically restored and are then closed again into the gradually tapered shape, whereby the distal end faces 40b thereof are brought into abutment with the outer circumferences of the locking legs 13, and the return of the locking legs 13 to the insertion position 36 is prevented (refer to FIG. 4A). In synchronism with this, the flange portion enters between the front surface of the mounting-subject member 30 and the fastening pieces 45, whereby the fastening pieces 45 are disposed above the front surface of the flange portion 12, and the movement of the locking legs 13 in the dislodgement direction is restricted (refer to FIG. 4B).

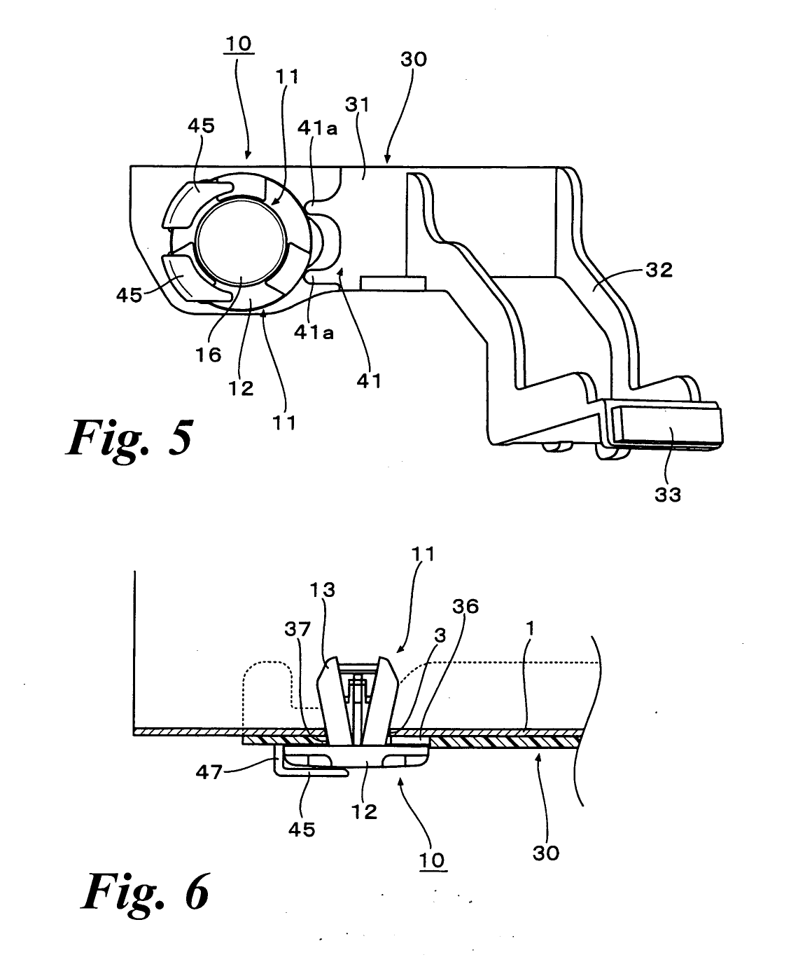

Namely, in the clip 10, the return of the locking legs 13 to the insertion position 36 is prevented by the pair of elastic pieces 40, 40, which constitute the unidirectional-movement-prevention unit, while the flange portion 12 is fastened by the fastening pieces 45, whereby the locking legs 13 are held without the dislodgement. Thus, the clip 10 can be held firmly in the fixing position 37 of the insertion hole 35 by both the pair of elastic pieces 40 and the fastening pieces 45. As a result of this, even if an unexpected external force is exerted on the clip 10 in such a way that a thrusting force is exerted on the clip 10 from an opposite side to the side where the clip 10 is inserted or even if a prizing force is exerted on the flange portion, the clip is surely prevented from falling off of the mounting-subject member 30, and hence, the clip 10 can be surely attached to the mounting-subject member 30. FIG. 5 shows a state where the clip 10 is attached to the mounting-subject member 30.

In this attachment structure, as described above, the clip 10 can be attached to the mounting-subject member 30 by simply inserting the locking legs 13 of the clip 10 from the insertion position 36 of the insertion hole 35 and moving them to the fixing position 37, thereby improving the workability in attachment. Further, the locking legs 13 of the clip 10 may only have to be lightly inserted and do not have to be strongly inserted as in Patent Documents 1, 2 cited above. Thus, the attachment work is facilitated.

In this embodiment, the pair of elastic pieces 40, 40, which constitute the unidirectional-movement-prevention unit, are provided to extend towards the center C of the locking legs 13 at the distal ends thereof when the locking legs 13 are positioned in the fixing position 37 (refer to FIG. 4A). Thus, for example, even if the outside diameter of the locking legs 13 is changed to some extent, the pair of elastic pieces 40, 40 can be brought into abutment with the outer circumferences of the locking legs 13 when the locking legs 13 attempt to move towards the fixing position 37, whereby the moving back of the locking legs 13 towards the fixing position 36 can be surely restricted.

Further, since the pair of elastic pieces 40, 40 extend into the gradually tapered shape, when the locking legs 13 move from the insertion position 36 to the fixing position 37 as described above, the locking legs 13 move accordingly while pressing against the inner surfaces 40a of the pair of elastic pieces 40, 40 to thereby forcibly expand the elastic pieces 40, 40 outwards. Thus, there being no need to move the locking legs 13 with a strong force, the locking legs 13 can be moved smoothly with a relatively light force. Further, when the locking legs 13 are disposed in the fixing position 37, the distal end faces of the pair of elastic pieces 40, 40 which are restored into the gradually tapered shape are brought into abutment with the outer circumferences of the locking legs 13 with good balance. Thus, the moving back of the locking legs 13 can be surely restricted, thereby firmly holding the locking legs 13.

As described above, the flange portion 12 which rides on the step portion 41 when the locking legs 13 are inserted into the insertion hole 35 is inclined downwards at the front portion with respect to the moving direction thereof (refer to FIG. 3B). Thus, the flange portion 12 is allowed to easily plunge under the fastening pieces 45, thereby improving the workability in attachment of the clip 10. Additionally, when the flange portion 12 is moved to the fixing position 37, as shown in FIGS. 4A and 5, both the side portions 41a, 41a of the step portion 41 are brought into engagement with the circumferential edge of the flange portion 12. Thus, the moving back of the locking legs 13 to the insertion position 36 can be further surely restricted.

After the clip 10 is attached to the mounting-subject member in the way described heretofore, the locking legs 13 that protrude from the rear side of the mounting hole 3 is aligned with the mounting hole 3 in the mount-base member 1 for insertion thereinto, and the mounting-subject member 30 is brought into abutment with a front surface of the mount-base member 1. Thereafter, the pin 15 is inserted deeper into the grommet 11, whereby the plural locking legs 13 are expanded diametrically so as to be brought into engagement with the circumferential edge on the rear side of the mounting hole 3. Thus, the mounting-subject member 30 can be fixed to the mount-base member 1 via the clip 10 as shown in FIG. 6. And, the external member 5 (refer to FIG. 1) disposed on the outer side of the mount-base member 1 is supported by the elastic member 33 at the distal end of the support portion 32 of the mounting-subject member 30 fixed to the mount-base member 1 so as to be held firmly without any looseness.

In this embodiment, the two-piece pin made up of the grommet 11 and the pin 15 is adopted as the clip 10 that is attached to the mounting-subject member 30. Therefore, the mounting-subject member 30 can be fixed to the mount-base member 1 by simply inserting the locking legs 13 into the mounting hole 3 and inserting the pin 15 deeper after the clip is attached to the mounting-subject member 30, thereby improving the workability. Further, when the locking legs 13 are inserted into the mounting hole 3, the insertion resistance can be reduced.

When the mounting-subject member is fixed to the mount-base member by use of the conventional two-piece clip, the series of operations is necessary which includes aligning the insertion hole in the mounting-subject member with the mounting hole in the mount-base member, inserting the two-piece clip into both the holes, and inserting the pin into the grommet. Thus, the attachment work becomes complex and much time has to be taken. Contrary, in the attachment structure of this embodiment, since the two-piece clip can be attached to the mounting-subject member 30 in advance, the attachment work can be carried out simply and quickly.

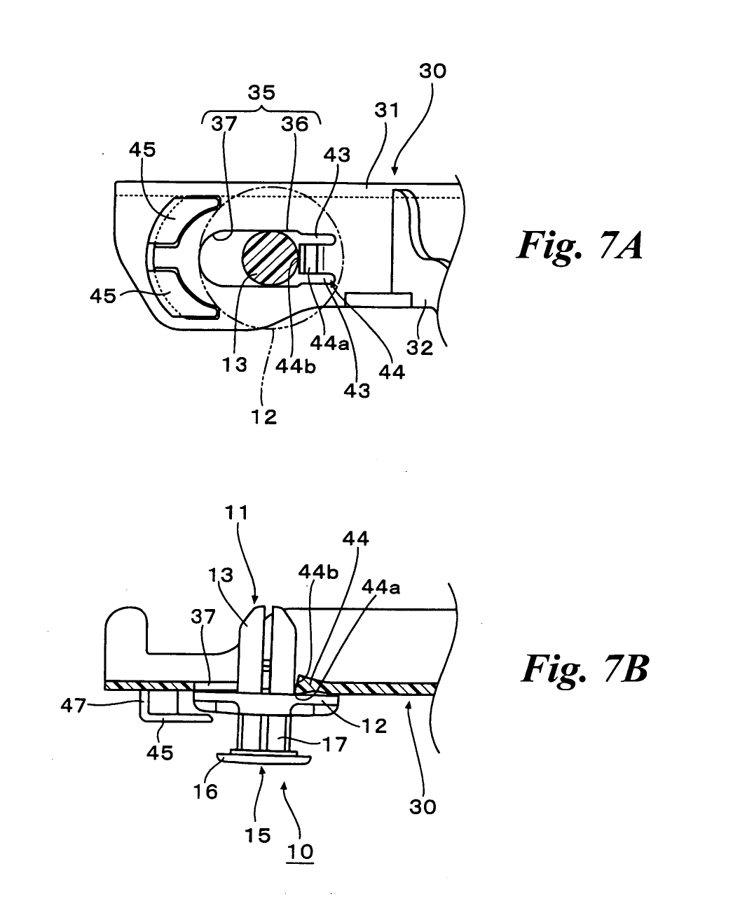

FIGS. 7A to 9 show another embodiment of an attachment structure of a clip and a mounting-subject member according to the invention. Like reference numerals will be given to substantially like portions to those of the above-described embodiment, and the description thereof will be omitted here.

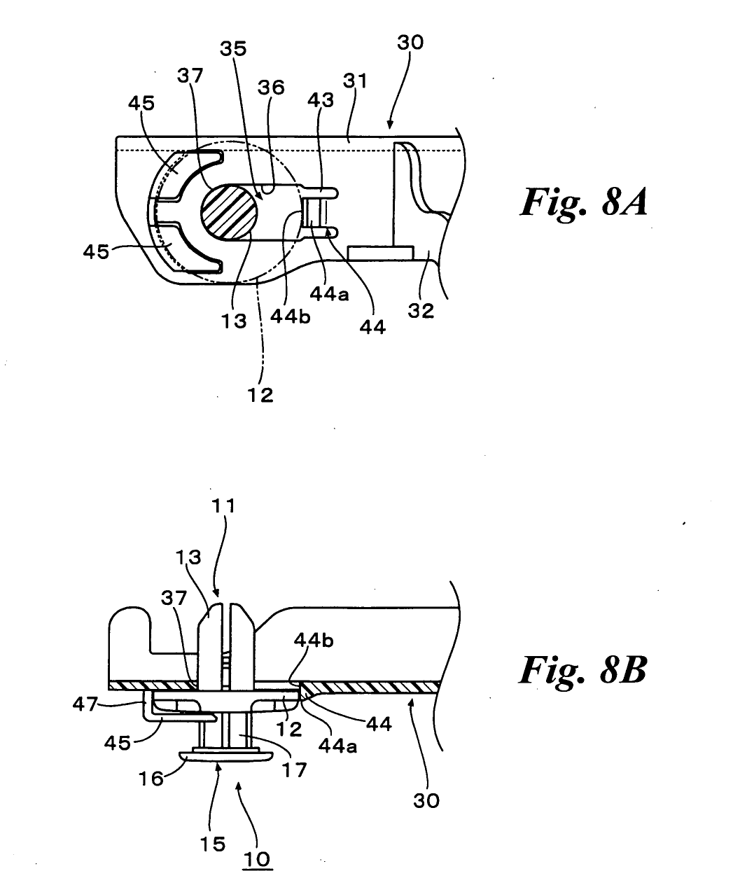

In this embodiment, compared with the previous embodiment, the structure of a unidirectional-movement-prevention unit is different. Namely, an insertion hole 35 in a mounting-subject member 30 has an elongated hole shape which extends long in one direction as shown in FIGS. 7A, 8A. One end side (a support portion 32 side) with respect to a length direction constitutes an insertion position 36, while the other end side with respect to the length direction constitutes a fixing position 37, and the insertion position 36 and the fixing position 37 communicate with each other so that locking legs 13 can move therein. Then, a pair of slits 43, 43 which extend towards the support portion 32 side are formed in an inner circumference of the insertion hole 35 having the elongated hole shape at an insertion position 36 side, and a flexible elastic claw piece 44 is formed via the pair of slits 43, 43 to extend towards the fixing position 37.

A projecting portion 44a of a certain height is provided at a free end of the elastic claw piece 44 on a clip insertion side so as to project therefrom. When a clip is inserted, this elastic claw piece 44 is pressed against by a flange portion 12 to thereby be deflected in the inserting direction of the locking legs 13 (refer to FIG. 7B), so that a distal end face 44b of the elastic claw piece 44 is brought into engagement with an outer circumference of the flange portion 12 when the locking legs 13 move to the fixing position 37 (refer to FIGS. 8A, 88). In this embodiment, this elastic claw piece 44 constitutes the “unidirectional-movement-prevention unit” of the invention.

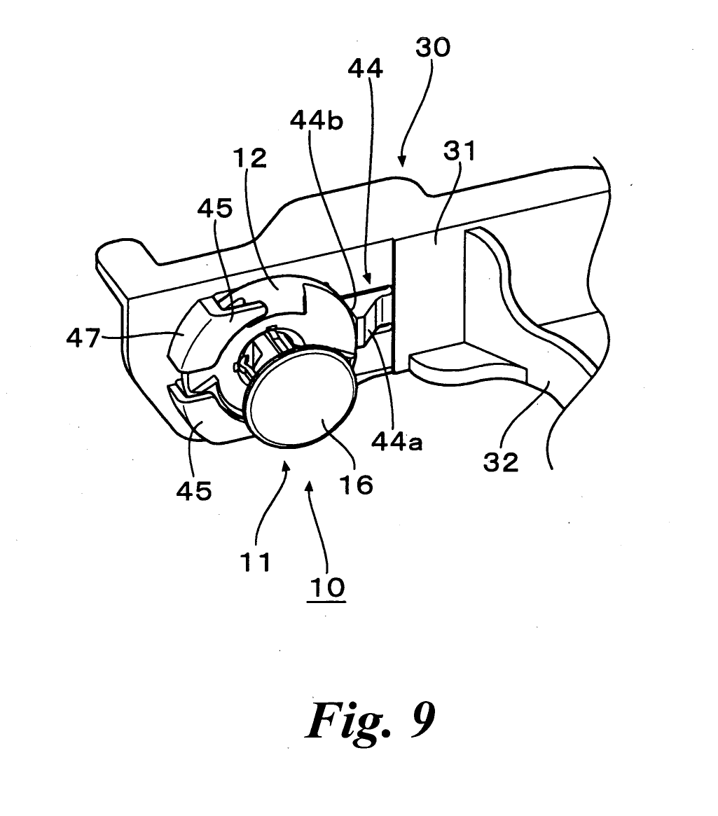

When the locking legs 13 is inserted at the insertion position 36 of the insertion hole 35, the flange portion 12 presses against the projecting portion 44a, whereby the elastic claw piece 44 is deflected in the inserting direction (refer to FIG. 7B). Thereafter, when the locking legs 13 are moved to the fixing position 37 and the flange portion 12 moves away from an upper surface of the projecting portion 44a of the elastic claw piece 44, the elastic claw piece 44 is elastically restored and are brought into engagement with an outer circumference of the flange portion 12, whereby not only is the return of the locking legs 13 prevented, but also the flange portion 12 is fastened by fastening pieces 45, so that the locking legs 13 are prevented from being dislodged and the locking legs 13 are held in the fixing position 37. Thus, the clip 10 can be attached to the mounting-subject member 30 as shown in FIG. 9. According to this embodiment, when the locking legs 13 are moved to the fixing position 37 of the insertion hole 35, the elastic claw piece 44, which constitute the unidirectional-movement-prevention unit, is brought into engagement with the outer circumference of the flange portion 12 having a larger diameter. Thus, the moving back of the locking legs 13 towards the insertion position 36 can be surely restricted.

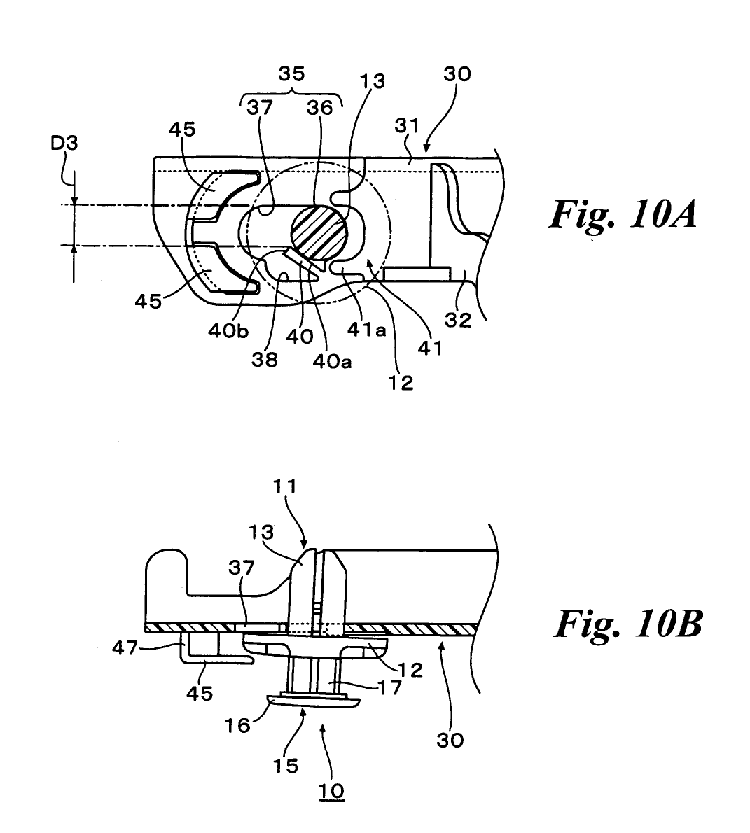

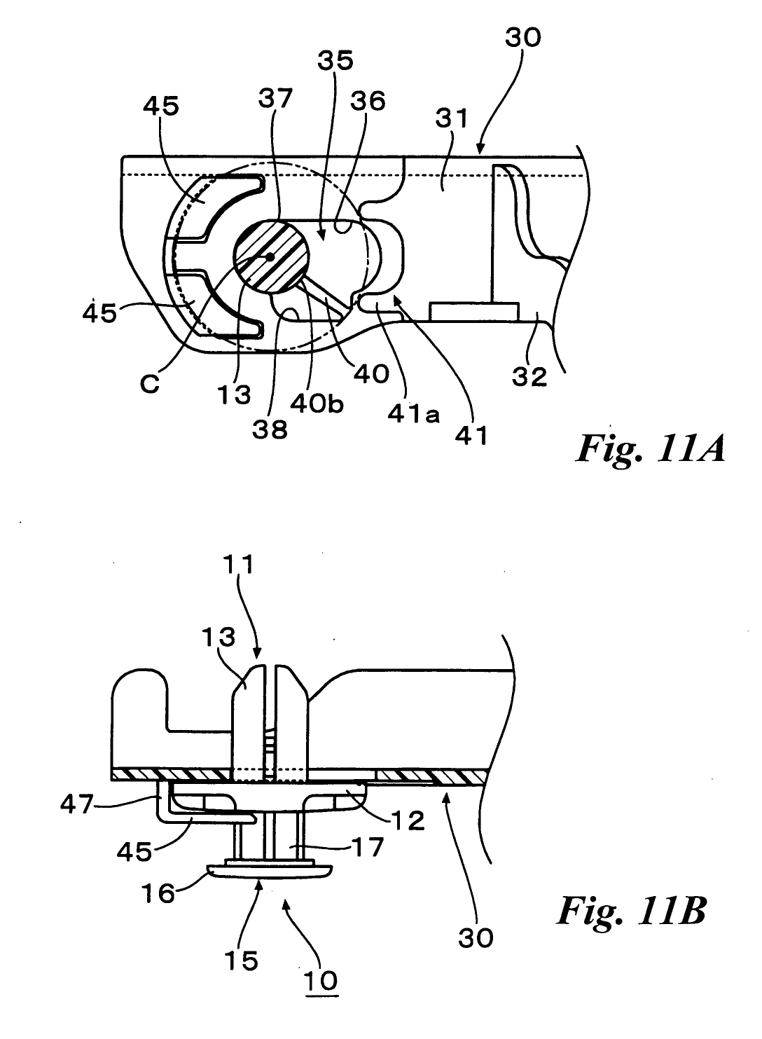

FIGS. 10A to 11B show a further embodiment of an attachment structure of a blip and a mounting-subject member according to the invention. Like reference numerals will be given to substantially like portions to those of the previously-described embodiment, and the description thereof will be omitted here.

Also in this embodiment, the structure of a unidirectional-movement-prevention unit is different. Namely, while the pair of elastic pieces 40, 40 have the gradually tapered shape in the embodiment illustrated in FIGS. 1 to 6, this embodiment differs in that a unidirectional-movement-prevention unit is made up of a single elastic piece 40.

As shown in FIGS. 10A, 11B, a clearance groove 38 is provided in one side portion of an insertion hole 35 which extends along a moving direction of locking legs 13 between an insertion position 36 and a fixing position 37, and a flexible elastic piece 40 extends from an inner circumference of the clearance groove 38 at an insertion position 36 side thereof. The elastic piece 40 extends towards an axis or center C of the locking legs 13 when the locking legs 13 are positioned in the fixing position 37 at a distal end thereof (refer to FIG. 11A), and a distance D1 between the distal end of the elastic piece 40 and one side of the insertion hole 35 which lies opposite to the side where the elastic piece 40 is provided (refer to FIG. 10A) is set smaller than at least an outside diameter of the locking legs 13.

Also in this embodiment, the locking legs 13 are inserted at the insertion position 36 of the insertion hole 35 and are then moved towards the fixing position 37 while deflecting the elastic piece 40 towards the clearance groove 38, whereby the return of the locking legs 13 is prevented by the elastic piece 40 constituting the unidirectional-movement-prevention unit and a clip 10 can be attached to a mounting-subject member 30 while holding the locking legs 13 without the dislodgement.

Although the above embodiments use the two-piece clip 10 made up of the grommet 11 and the pin 15, the invention is not limited thereto, and hence, any clip may be used as long as such clip includes a flange portion and a locking leg (locking legs). For example, there may be used a clip including a flange portion, a stem portion extending from one surface of the flange portion and a pair of locking legs extending into an anchor-like shape from both sides of a distal end of the stem portion.

1. An attachment structure of a clip and a mounting-subject member,
wherein the clip includes:
a flange portion; and
a locking leg extending from a rear surface of the flange portion to be inserted into a mounting hole in a mount-base member to thereby fix the mounting-subject member to the mount-base member,
wherein the clip comprises a two-piece clip having a grommet having the flange portion and the locking leg and a pin to be inserted into the grommet,
wherein the clip is inserted into the insertion hole in the mounting-subject member and the mounting hole in the mount-base member in a state where the pin is inserted halfway into the grommet,
wherein the locking leg is diametrically expanded to be fixed in the mounting hole by inserting the pin deeper into the grommet, and
wherein the mounting-subject member includes:
an insertion hole having an insertion position which enables the locking leg of the grommet to be inserted along an inserting direction from a front side of the mounting-subject member so as to protrude from a rear side thereof and a fixing position which communicates with the insertion position and which enables the locking leg to be moved in a direction perpendicular to the inserting direction to thereby hold the locking leg at a certain location;
a fastening piece which is disposed above a front surface of the flange portion and which restricts a movement of the locking leg in a dislodgement direction when the locking leg is moved to the fixing position and the flange portion is located in the fixing position; and
a unidirectional-movement-prevention unit which permits an insertion of the locking leg to the insertion position of the insertion hole and which restricts a returning movement of the locking leg to the insertion position when the locking leg has moved to the fixing position.

2. The structure of claim 1,
wherein the unidirectional-movement-prevention unit comprises a flexible elastic piece extending from an inner circumference of the insertion hole at a side of the insertion position towards an axis of the locking leg when positioned in the fixing position.

3. The structure of claim 2,
wherein the elastic piece includes a pair of elastic pieces respectively extending from both inner circumferential positions of the insertion hole at the insertion position side to have a gradually tapered shape.

4. The structure of claim 1,
wherein the unidirectional-movement-prevention unit includes an elastic claw piece extending from an inner circumference of the insertion hole at a side of the insertion position towards a side of the fixing position and being deflectable in the inserting direction of the locking leg, and
wherein the elastic claw piece is brought into engagement with an outer circumference of the flange portion when the locking leg moves to the fixing position.

5. The structure of claim 1,
wherein a step portion of a certain height is provided on the clip insertion side of the mounting-subject member a circumferential edge of the insertion position of the insertion hole, and
wherein the flange portion of the clip rides on the step portion when the flange portion is positioned in the insertion position of the insertion hole, and the step portion is brought into engagement with a circumferential edge of the flange portion when the flange portion is positioned in the fixing position.

6. (canceled)
